(19) United States
(12) Patent Application Publication
(10) Pub. No.: US 2006/0055852 A1
(43) Pub. Date: Mar. 16, 2006

(54) Semi-transmissive liquid crystal display device and method of manufacturing the same

(75) Inventors: Hidefumi Yoshida, Kawasaki (JP); Yasutoshi Tasaka, Kawasaki (JP); Kunihiro Tashiro, Kawasaki (JP); Katsufumi Ohmuro, Kawasaki (JP)

Correspondence Address: GREER, BURNS & CRAIN, 300 S WACKER DR, 25TH FLOOR, CHICAGO, IL, 60606, US

(73) Assignee: FUJITSU DISPLAY TECHNOLOGIES CORPORATION.

(21) Appl. No.: 11/046,536

(22) Filed: Jan. 28, 2005

(30) Foreign Application Priority Data
Sep. 10, 2004 (JP) 2004-264335

(51) Int. Cl. G02F 1/1335

(52) U.S. Cl. 349/114

(57) ABSTRACT

A control electrode is formed in the same layer as a gate bus line. A reflective electrode is formed on an insulating film which covers both the gate bus line and the control electrode. The control electrode is electrically connected to a source electrode of a TFT. The reflective electrode is capacitively coupled to the control electrode. An insulating film is formed on both the TFT and the reflective electrode, and an aperture from which the reflective electrode is exposed is formed. Thereafter, a transparent conductive film is formed on the entire surface. The transparent conductive film is patterned to form a transparent electrode. The transparent electrode in a transmissive region is electrically connected to the source electrode of the TFT.

### CROSS-REFERENCE TO RELATED APPLICATIONS

This application is based on and claims priority of Japanese Patent Application No. 2004-264335 filed on Sep. 10, 2004, the entire contents of which are incorporated herein by reference.

### BACKGROUND OF THE INVENTION

1. Field of the Invention

The present invention relates to a semi-transmissive liquid crystal display device displaying images by use of a backlight under low light conditions and by use of reflection of external light under well-lit conditions, and to a method of manufacturing the same.

2. Description of the Prior Art

Liquid crystal display devices are advantageous in that they are thin and light, as well as have low power consumption characteristics owing to its low-voltage drive capability, and are therefore widely used in various electronic devices. In particular, active matrix liquid crystal display devices including thin film transistors (TFTs) provided in respective picture elements as switching elements also exhibit an excellent display quality equivalent to cathode-ray tubes (CRTs). Accordingly, they are widely used for televisions, displays for personal computers or the like.

In general, a liquid crystal display device includes two substrates placed to face each other, and liquid crystal sealed between the substrates. TFTs, picture element electrodes and the like are formed on one of the substrates, while color filters, a common electrode and the like are formed on the other substrate. The substrate on which the TFTs, the picture element electrodes and the like are formed will be hereinafter referred to as a TFT substrate, and the substrate to be placed to face the TFT substrate will be hereinafter referred to as a counter substrate. Furthermore, a structure formed by sealing the liquid crystal between the TFT substrate and the counter substrate will be hereinafter referred to as a liquid crystal panel.

A liquid crystal display device includes: a transmissive liquid crystal display device having a backlight as a light source and displaying images by use of light which passes through a liquid crystal panel; a reflective liquid crystal display device displaying images by use of reflection of external light (natural light or lamplight); and a semi-transmissive liquid crystal display device displaying images by use of a backlight under low light conditions and by use of reflection of external light under well-lit conditions.

FIG. 1A is a schematic view showing the configuration of a semi-transmissive liquid crystal display device (U.S. Pat. No. 5,753,937). A transparent electrode 12a made of a transparent conductive material such as indium-tin oxide (ITO) and a reflective electrode 12b made of metal having high reflectance such as aluminum, are formed in the respective picture element regions of a TFT substrate 11. The transparent electrode 12a and the reflective electrode 12b, which are in the same picture element region, are electrically connected to each other. Here, a region in which the transparent electrode 12a is formed is referred to as a transmissive region, and a region in which the reflective electrode 12b is formed is referred to as a reflective region.

A common electrode 22 made of a transparent conductive material such as ITO is formed on one surface of a counter substrate 21, the surface facing the TFT substrate 11 (lower side in FIG. 1A). The TFT substrate 11 and the counter substrate 21 are placed in such a manner that the common electrode 22 is placed to face both the transparent electrode 12a and the reflective electrode 12b, and that a liquid crystal layer 30 is interposed between the substrates. In this example, it is assumed that the liquid crystal layer 30 is formed of a vertical alignment-type liquid crystal (a liquid crystal having negative dielectric anisotropy). The surfaces of the picture element electrodes 12a and 12b, as well as the surface of the common electrode 22 are all covered with a vertical alignment film (not shown).

A first circularly polarizing plate 31 is placed under the TFT substrate 11. A second circularly polarizing plate 32 is placed above the counter substrate 21. In addition, a backlight (not shown) is placed under the TFT substrate 11. One of the first and second circularly polarizing plates 31 and 32 is a right-hand circularly polarizing plate. The other one is a left-hand circularly polarizing plate. These first and second circularly polarizing plates 31 and 32 are placed so that the optical axes are orthogonal to each other.

In the above-described semi-transmissive liquid crystal display device, liquid crystal molecules 30a are aligned substantially perpendicular to the surfaces of the substrates when a voltage is not applied between the transparent electrode 12a and the common electrode 22 and between the reflective electrode 12b and the common electrode 22. In this case, in the transmissive region, the light emitted from the backlight passes through the first circularly polarizing plate 31 and the transparent electrode 12a, and then enters the liquid crystal layer 30 and passes through the liquid crystal layer 30 without changing its polarization direction. Thereafter, the light passage is blocked by the second circularly polarizing plate 32. Specifically, black is displayed in the transmissive region. Moreover, in the reflective region, the light which comes from above the liquid crystal panel passes through the second circularly polarizing plate 32 and enters the liquid crystal layer 30. The light in the liquid crystal layer 30 is then reflected by the reflective electrode 12b to travel in the upward direction, and is blocked by the second circularly polarizing plate 32. Accordingly, black is displayed in the reflective region.

As shown in FIG. 1A, when a voltage which is higher than the specific voltage (threshold voltage) is applied between the transparent electrode 12a and the common electrode 22 and between the reflective electrode 12b and the common electrode 22, the liquid crystal molecules 30a are aligned in an oblique direction relative to the surfaces of the substrates. In this way, in the transmissive region, the light emitted from the backlight passes through the first circularly polarizing plate 31 and the transparent electrode 12a, and then enters the liquid crystal layer 30. In the liquid crystal layer 30, the polarization direction of the light is changed, and thereby the light can pass through the second circularly polarizing plate 32. Specifically, a bright color is displayed in the transmissive region. In the reflective region, light comes from above the liquid crystal panel, passes through the second circularly polarizing plate 32, enters the liquid crystal layer 30, and is reflected by the reflective electrode 12b to travel in the upward direction. Here, in similar way, the polarization direction of the light is changed while passing through the liquid crystal layer 30 and thereby the light can pass through the second circularly polarizing plate 32.

It is possible to control the amount of light emitting upwardly from the liquid crystal panel by controlling a voltage to be applied between the transparent electrode 12a and the common electrode 22 and between the reflective electrode 12b and the common electrode 22. In addition, it is possible to display a desired image on the liquid crystal panel by controlling the amount of emitting light for every picture element.

Incidentally, in the semi-transmissive liquid crystal display device having a structure shown in FIG. 1A, while light passes through the liquid crystal layer 30 only one time in the transmissive region, light passes through the liquid crystal layer 30 two times in the reflective region (to and fro). Accordingly, there arises difference between the lights passing through the transmissive region and the reflective region as to the variances in the polarizing direction. If the same amount of lights enter the transmissive region and the reflective region, the amount of light passing through the second circularly polarizing plate 32 unfavorably differs between the regions.

FIG. 1B is a graph showing transmittance-applied voltage characteristic (hereinafter referred to as T-V characteristic) in the transmissive region and reflectance-applied voltage characteristic (hereinafter referred to as R-V characteristic) in the reflective region, in which the horizontal axis represents the applied voltage and the longitudinal axis represents transmittance and reflectance (arbitrary units). As shown in the FIG. 1B, in the liquid crystal display device having the structure shown in FIG. 1A, T-V characteristic and R-V characteristic significantly differ from each other. For this reason, even when a voltage to be applied is appropriately set for this liquid crystal display device which is used, for example, as a transmissive liquid crystal display device in order that an excellent display performance can be exhibited, an excellent display cannot be achieved if this liquid crystal display device is used as a reflective liquid crystal display device.

Japanese Unexamined Patent Publication No. 2003-255375 proposes a semi-transmissive liquid crystal display device in which a reflective electrode is connected to a TFT, in which a transparent electrode is formed on the reflective electrode via an insulating film, and in which the transparent electrode is capacitively coupled to the reflective electrode, in order to avoid occurrence of flicker and image sticking which are caused by the difference of work functions between the metal constituting the reflective electrode and the metal constituting the common electrode. In this semi-transmissive liquid crystal display device, the same voltage is applied to the transparent electrode in the reflective region and to the transparent electrode in the transmissive region via the reflective electrode. However, this semi-transmissive liquid crystal display device also has the aforementioned problem because the thickness of the liquid crystal layer is the same between the transmissive region and the reflective region.

In order to solve the aforementioned problems, as shown in FIG. 2A, a semi-transmissive liquid crystal display device is proposed in which an insulating film 13 made of transparent resin is formed on the entire surface of the TFT substrate 11 after forming the reflective electrode 12b on the TFT substrate 11, and in which the transparent electrode 12a is formed thereon. In the liquid crystal display device having the structure shown in FIG. 2A, the voltage to be applied to the liquid crystal layer 30 in the reflective region is lowered by the amount corresponding to the insulating film 13 compared to the voltage to be applied to the liquid crystal layer 30 in the transmissive region. Accordingly, as shown in FIG. 2B, it is made possible to reduce the difference between T-V characteristic and R-V characteristic.

U.S. Pat. Nos. 6,281,952 and 6,195,140 propose a semi-transmissive liquid crystal display device in which the transparent electrode 12a is formed on the TFT substrate 11 in the transmissive region, and in which a insulating film 14 is formed on the TFT substrate 11 in the reflective region and the reflective electrode 12b is formed thereon, as shown in FIG. 3A. In this liquid crystal display device, cell gap (2d) in the transmissive region is set to be twice the cell gap (d) in the reflective region. As shown in FIG. 3B, R-V characteristic substantially matches T-V characteristic in this liquid crystal display device. Accordingly, it is made possible to obtain an excellent display quality when this liquid crystal display device is used not only as a transmissive liquid crystal display device, but also as a reflective liquid crystal display device.

However, a thick insulating layer made of resin or the like needs to be formed in the semi-transmissive liquid crystal display devices shown in FIGS. 2A and 3A. For this reason, there arises a problem that manufacturing processes become complicated and thereby manufacturing cost is increased. Moreover, the semi-transmissive liquid crystal display device shown in FIG. 3A has following problems. Specifically, irregularity occurs in the alignment directions of the liquid crystal molecules at irregular portions, causing the optical losses. In addition, when bead-shaped spacers are used, impact and the like cause the spacers to move from top to bottom of the irregular portions and the cell thickness is changed, thereby incurring deterioration in a display quality.

### SUMMARY OF THE INVENTION

Accordingly, an object of the present invention is to provide a semi-transmissive liquid crystal display device which is capable of exhibiting an excellent display quality when used either as a transmissive liquid crystal display device or as a reflective liquid crystal display device and which can be manufactured easily, and a method of manufacturing the same.

The aforementioned problems can be solved by a semi-transmissive liquid crystal display device which is constituted of first and second substrates placed so as to face each other and a liquid crystal sealed between the first and second substrates, and which includes a transmissive region and a reflective region in one picture element region. Here, the semi-transmissive liquid crystal display device is characterized in that the first substrate includes a TFT, a transparent electrode which is placed in the transmissive region and receives a display voltage via the TFT, a control electrode which is placed in the reflective region and receives the display voltage via the TFT, and a reflective electrode which is placed in the reflective region and is capacitively coupled to the control electrode, and characterized in that the second substrate includes a common electrode facing both the transparent electrode and the reflective electrode.

In the present invention, the TFT is connected to both the transparent electrode and the control electrode, and the reflective electrode is capacitively coupled to the control electrode. Accordingly, the ratio of the capacitance between the reflective electrode and the control electrode to the capacitance between the reflective electrode and the common electrode determines the voltage to be applied to the reflective electrode, and thereby the voltage becomes lower than the voltage to be applied to the transparent electrode. Thus, the difference between transmittance-applied voltage characteristic in the transmissive region and reflectance-applied voltage characteristic in the reflective region is reduced, offering an excellent display quality even when the semi-transmissive liquid crystal device of the present invention is used either as a transmissive liquid crystal display device or as a reflective liquid crystal display device.

The aforementioned problems can be solved by a method of manufacturing a semi-transmissive liquid crystal display device which includes the steps of: forming a first metal film on a first substrate; forming a gate bus line and a control electrode by patterning the first metal film; forming a first insulating film on an entire upper surface of the first substrate; forming a first contact hole which reaches the control electrode in the first insulating film; forming a semiconductor film constituting an active layer of a TFT on a predetermined region of the first insulating film; forming a second metal film on the first insulating film; forming, by patterning the second metal film, a data bus line, source/drain electrodes of the TFT, metal pad electrically connected to the control electrode via the first contact hole, and a reflective electrode capacitively coupled to the control electrode via the first insulating film; forming a second insulating film on the entire upper surface of the first substrate; forming a second contact hole, which reaches the metal pad, as well as an aperture from which the reflective electrode is exposed in the second insulating film; forming a transparent conductive film on the entire upper surface of the first substrate; forming a transparent electrode by patterning the transparent conductive film; and placing a second substrate including a common electrode so as to face the first substrate, and sealing a liquid crystal between the first substrate and the second substrate.

In the present invention, the gate bus lines and the control electrode are formed at the same time, and the data bus lines and the reflective electrode capacitively coupled to the control electrode are formed at the same time. Accordingly, a similar manufacturing process as that used for manufacturing a typical transmissive liquid crystal display device can be adopted to manufacture a semi-transmissive liquid crystal display device including the transparent electrode and the control electrode which are connected to the TFT and the reflective electrode capacitively coupled to the control electrode. In this way, a semi-transmissive liquid crystal display device with an excellent display quality can be manufactured at low cost.

The aforementioned problems can be solved by a semi-transmissive liquid crystal display device which includes: a first substrate including a transparent electrode which allows light to pass through and a reflective electrode which reflects light; a second substrate including a common electrode facing both the transparent electrode and the reflective electrode of the first substrate; and a liquid crystal layer formed of a liquid crystal sealed between the first substrate and the second substrate. Here, the semi-transmissive liquid crystal display device is characterized in that a plurality of dielectric films is interposed between the reflective electrode and the common electrode, and the dielectric films divide a reflective region defined by the reflective electrode into a plurality of regions each having different reflection-applied voltage characteristic from one another.

If the dielectric film (insulating film) is interposed between the reflective electrode and the common electrode, the voltage to be applied to the liquid crystal is lowered by the amount corresponding to the dielectric film, thereby changing reflectance-applied voltage characteristic in the reflective region. Appropriate setting of parameters (i.e., thickness, relative dielectric constant, density and the like) of the dielectric film makes it possible to make reflectance-applied voltage characteristic in the reflective region closer to transmittance-applied voltage characteristic in the transmissive region to some extent. However, there is a limitation.

In this connection, in the present invention, the plurality of dielectric films is interposed between the reflective electrode and the common electrode, and the dielectric films divide the reflective region into a plurality of regions each having different reflection-applied voltage characteristic from one another. Reflectance-applied voltage characteristic in the reflective region (the entire reflective region) becomes one in which R-V characteristic in each divided region is combined. Therefore, R-V characteristic in the reflective region can be made further closer to the T-V characteristic in the transmissive region, and an excellent display quality can be obtained when the liquid crystal display device of the present invention is used either as a transmissive liquid crystal display device or as a reflective liquid crystal display device.

### BRIEF DESCRIPTION OF THE DRAWINGS

FIG. 1A is a schematic view showing the configuration of a semi-transmissive liquid crystal display device of a conventional example, FIG. 1B is a graph showing T-V characteristic in the transmissive region and R-V characteristic in the reflective region of the same semi-transmissive liquid crystal display device.

FIG. 2A is a schematic view showing the configuration of a semi-transmissive liquid crystal display device of another conventional example, FIG. 2B is a graph showing T-V characteristic in the transmissive region and R-V characteristic in the reflective region of the same semi-transmissive liquid crystal display device.

FIG. 3A is a schematic view showing the configuration of a semi-transmissive liquid crystal display device of still another conventional example, FIG. 3B is a graph showing T-V characteristic in the transmissive region and R-V characteristic in the reflective region of the same semi-transmissive liquid crystal display device.

FIG. 4 is a plane view showing a semi-transmissive liquid crystal display device of a first embodiment of the present invention.

FIG. 5 is a cross-sectional view taken along the I-I line in FIG. 4.

FIG. 6 is a cross-sectional view taken along the II-II line in FIG. 4.

FIG. 7 is a plan view showing a semi-transmissive liquid crystal display device of a second embodiment of the present invention.

FIGS. 8A and 8B are graphs each showing the results of simulation calculations performed for T-V characteristic in the transmissive region and for R-V characteristic in the reflective region of a VA mode semi-transmissive liquid crystal display device having 4 μm cell thickness in the transmissive region.

FIG. 9 is a plan view showing a semi-transmissive liquid crystal display device of a third embodiment of the present invention.

FIG. 10 is a cross-sectional view taken along the III-III line in FIG. 9.

FIGS. 11A to 11F are schematic views each showing the shape of a dielectric film.

FIGS. 12A and 12B are schematic views showing a method of forming polymer which determines the alignment direction of liquid crystal molecules in a liquid crystal layer.

FIG. 13 is a cross-sectional view showing a semi-transmissive liquid crystal display device of a fourth embodiment of the present invention.

FIG. 14 is a cross-sectional view showing a semi-transmissive liquid crystal display device of a fifth embodiment of the present invention.

FIGS. 15A to 15c are graphs each showing the results of simulation calculations performed for T-V characteristic in the transmissive region and for R-V characteristic in the reflective region of a VA mode semi-transmissive liquid crystal display device having the structure shown in FIG. 14.

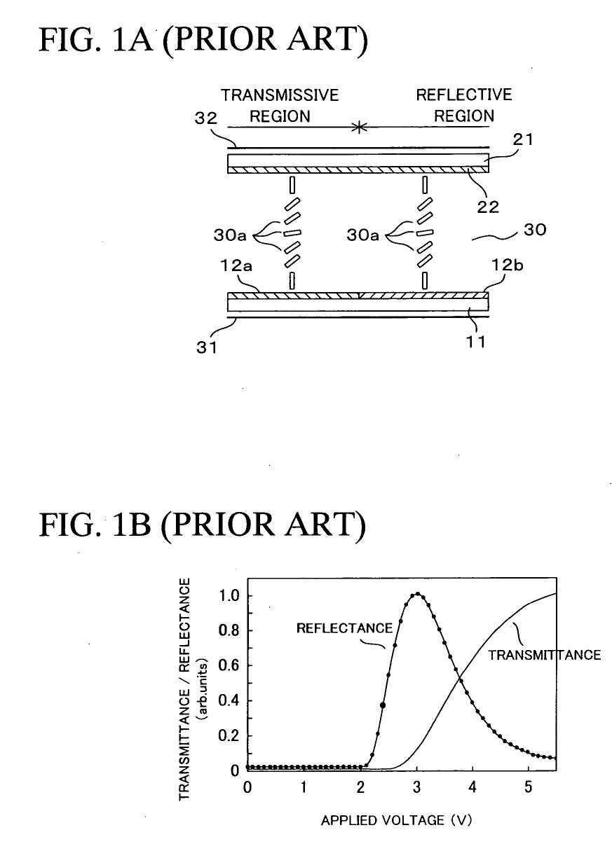

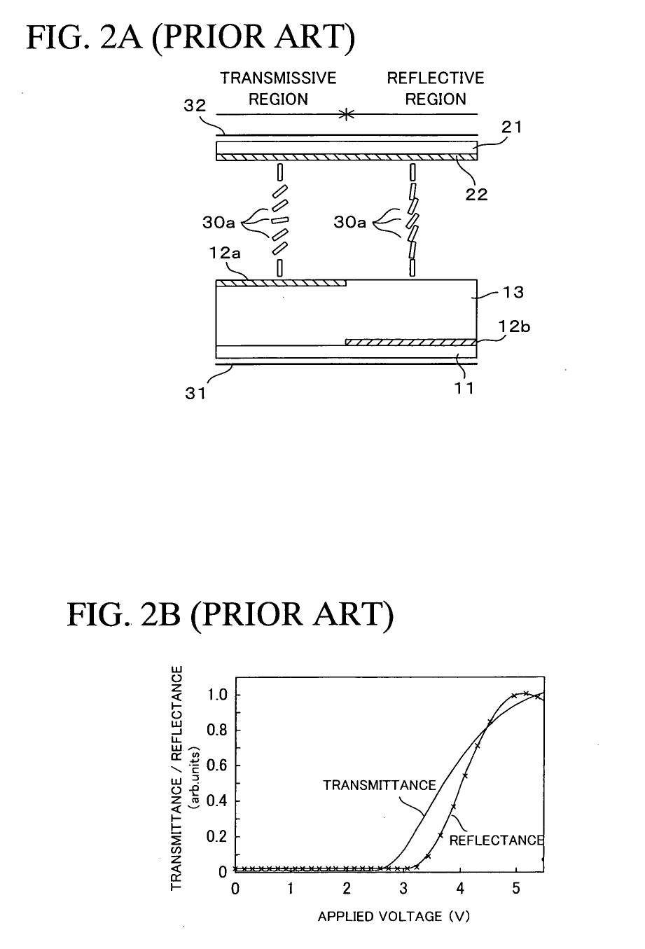

### DESCRIPTION OF THE PREFERRED EMBODIMENTS

Hereinafter, embodiments of the present invention will be described with reference to the accompanying drawings.

### First Embodiment

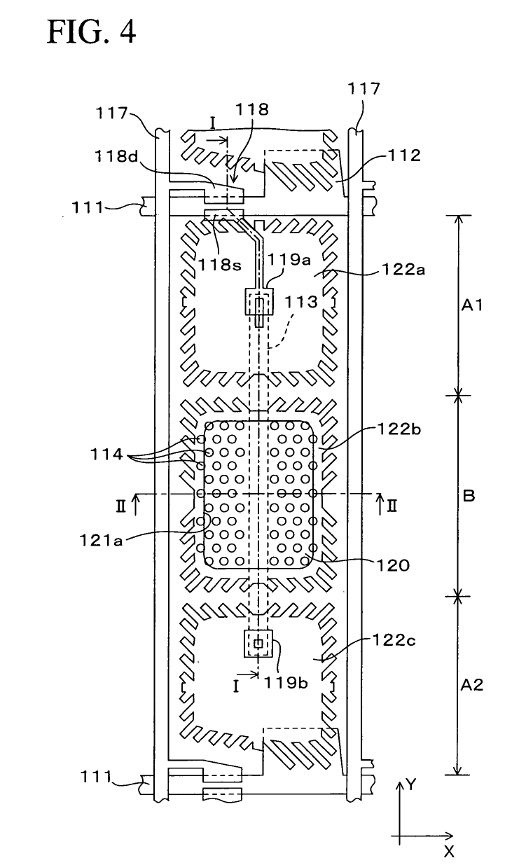

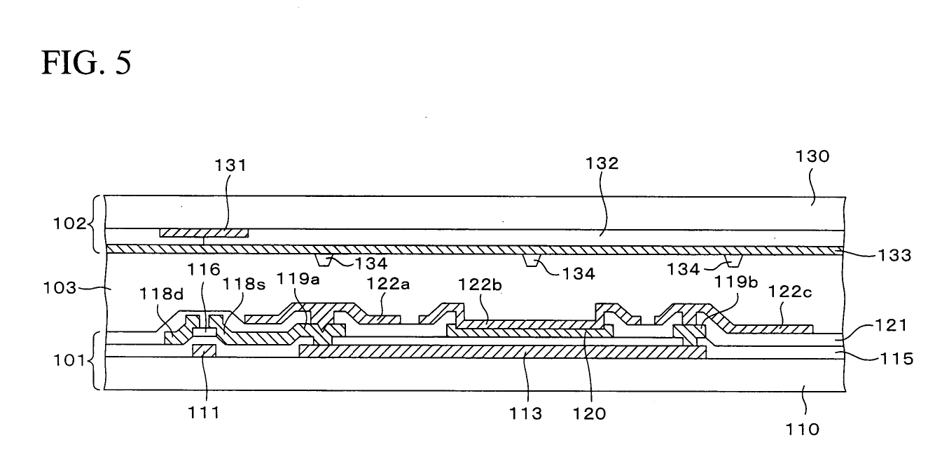

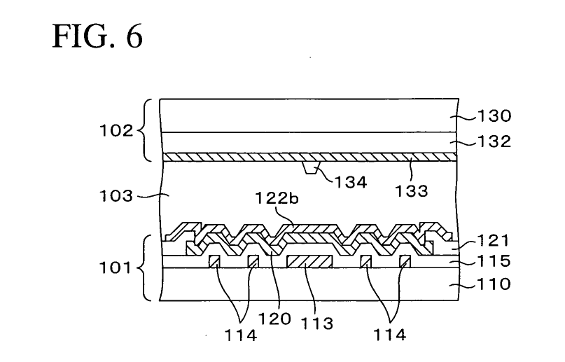

FIG. 4 is a plan view showing a semi-transmissive liquid crystal display device of a first embodiment of the present invention. FIG. 5 is a cross-sectional view taken along the I-I line in FIG. 4. FIG. 6 is a cross-sectional view taken along the II-II line in FIG. 4. Note that the FIG. 4 shows one picture element of the semi-transmissive liquid crystal display device.

As shown in FIGS. 5 and 6, the semi-transmissive liquid crystal display device of this embodiment includes: a TFT substrate 101; a counter substrate 102; and a liquid crystal layer 103 formed of vertical alignment-type liquid crystals (liquid crystals having negative dielectric anisotropy) sealed between the TFT substrate 101 and the counter substrate 102. A first circularly polarizing plate (not shown) is placed under the TFT substrate 101. A second circularly polarizing plate (not shown) is placed on the counter substrate 102. One of the first and second circularly polarizing plates is a right-hand circularly polarizing plate. The other one is a left-hand circularly polarizing plate. These first and second circularly polarizing plates are placed so that the optical axes are orthogonal to each other. In addition, a backlight (not shown) is placed under the TFT substrate 101.

As shown in FIG. 4, in the TFT substrate 101, a plurality of gate bus lines 111 extending in the horizontal direction (X direction) and a plurality of data bus lines 117 extending in the vertical direction (Y direction) are formed. Each of the rectangular regions defined by the gate bus lines 111 and the data bus lines 117 constitutes a picture element region. The size of a picture element region is as follows: approximately 100 μm long in the horizontal direction; and approximately 300 μm long in the vertical direction, for example.

In the liquid crystal display device of this embodiment, one picture element region is divided into three sub-picture element regions. In other words, in one picture element region, a first transmissive region A1, a reflective region B and a second transmissive region A2 are sequentially aligned in the vertical direction.

A TFT 118 and an auxiliary capacitor electrode 112 are provided in one picture element region. The auxiliary capacitor electrode 112 is formed integrally with the gate bus line 111, and is capacitively coupled to a picture element electrode of an upper side picture element adjacent thereto. This structure is called Cs-on-gate structure.

Moreover, the TFT 118 uses a part of the gate bus line 111 as a gate electrode. A source electrode 118s and a drain electrode 118d are placed facing each other with the gate bus line 111 interposed therebetween. The drain electrode 118d is connected to the data bus line 117. The source electrode 118s extends to the center portion of the first transmissive region A1 and is connected to a metal pad 119a.

The first and second transmissive regions A1 and A2 are respectively provided with transparent electrodes 122a and 122c, which are made of a transparent conductive material such as ITO. In addition, a reflective electrode 120, the surface of which is made of metal having high reflectance such as A1 (aluminum), is formed in the reflective region B. A transparent electrode 122b made of ITO is also formed on the reflective electrode 120. Slits are formed on the edge of each of the transparent electrodes 122a to 122c. These slits regulate the alignment directions of liquid crystal molecules when a voltage is applied.

A control electrode 113, which extends in the vertical direction from the center portion of the first transmissive region A1 to the center portion of the second transmissive region A2, is provided under the transparent electrodes 122a and 122c and the reflective electrode 120. As shown in FIG. 5, the transparent electrode 122a is electrically connected to the control electrode 113 and the source electrode 118s of the TFT 118, with a contact hole and the metal pad 119a interposed therebetween. Moreover, the transparent electrode 122c is also electrically connected to the control electrode 113, with the contact hole and the metal pad 119b interposed therebetween. Furthermore, the reflective electrode 120 is capacitively coupled to the control electrode 113 with a first insulating layer 115 interposed therebetween.

In addition, as shown in FIG. 6, a number of small round dot patterns 114, which are formed of a metal film, are formed under the reflective electrode 120. Irregularities corresponding to the shapes of these dot patterns 114 are formed on the surface of the reflective electrode 120. In this way, light is diffusely reflected on the surface of the reflective electrode 120.

Meanwhile, a black matrix (light blocking film) 131, a color filter 132, a common electrode 133 and alignment regulating protrusions 134 are formed on the counter substrate 102. The black matrix 131 is placed opposite to the gate bus line 111, to the data bus line 117, to the auxiliary capacitor electrode 112 and to the TFT 118, which are formed on the TFT substrate 101.

The color filters 132 are classified into three types of red (R), green (G), and blue (B). A color filter of any one color among these colors is placed in one picture element. Three picture elements of red (R), green (G), and blue (B) which are adjacently placed constitute one pixel, thereby making it possible to display various colors.

The common electrode 133 is made of a transparent conductive material such as ITO. In addition, a dielectric material such as resin is used to form the alignment regulating protrusions 134 so as to be conical in shape.

In the semi-transmissive liquid crystal display device constituted as described above in this embodiment, when a voltage is not applied to the transparent electrodes 122a and 122c and to the reflective electrode 120, liquid crystal molecules align substantially perpendicular to the surfaces of the substrates. In this case, in the transmissive regions A1 and A2, the light emitted from the backlight passes through the first circularly polarizing plate and the transparent electrodes 122a and 122c, and then enters the liquid crystal layer 103 and passes through the liquid crystal layer 103 without changing its polarization direction. Thereafter, the light passage is blocked by the second circularly polarizing plate. Specifically, black is displayed in the transmissive region. Moreover, in the reflective region B, the light which comes from above the liquid crystal panel passes through the second circularly polarizing plate and enters the liquid crystal layer 103. The light in the liquid crystal layer 103 is then reflected by the reflective electrode 120 to travel in the upward direction, and is blocked by the second circularly polarizing plate. Accordingly, black is also displayed in the reflective region B.

If a scanning signal is supplied to the gate bus line 111 while a display voltage is being applied to the data bus line 117, the TFT 118 is turned on, and thereby a voltage is applied to the transparent electrodes 122a and 122c, and to the reflective electrode 120. In this way, the liquid crystal molecules are aligned in an oblique direction relative to the surfaces of the substrates, and are aligned in a radial direction centered around the alignment regulating protrusions 134 when viewed from above the liquid crystal panel. In this case, in the transmissive regions A1 and A2, the light emitted from the backlight passes through the first circularly polarizing plate and the transparent electrodes 122a and 122c, and then enters the liquid crystal layer 103. In the liquid crystal layer 103, the polarization direction of the light is changed, and thereby the light can pass through the second circularly polarizing plate. Specifically, a bright color is displayed in the transmissive regions A1 and A2. In the reflective region B, light comes from above the liquid crystal panel, passes through the second circularly polarizing plate, enters the liquid crystal layer 103, and is reflected by the reflective electrode 120 to travel in the upward direction. Here, in similar way, the polarization direction of the light is changed while passing through the liquid crystal layer 103 and thereby the light can pass through the second circularly polarizing plate.

In this embodiment, a display voltage is supplied to the transparent electrodes 122a and 122c directly from the source electrode 118s of the TFT 118. In the reflective region B, in contrast, a display voltage is divided in the following ratio: that is, the ratio of the capacitance between the control electrode 113 and the reflective electrode 120 to the capacitance between the reflective electrode 120 and the common electrode 133. Accordingly, the voltage to be applied to the reflective electrode 120 becomes lower than the voltage to be applied to the transparent electrodes 122a and 122c. In this way, the difference between T-V characteristic in the transmissive regions A1 and A2 and R-T characteristic in the reflective region B is reduced, thereby making it possible to obtain an excellent display quality when the liquid crystal display device of this embodiment is used either as a transmissive liquid crystal display device or as a reflective liquid crystal display device.

Here, it is assumed that the first insulating film (gate insulating film) 115 is formed of a Si—N film having dg μm thickness and having dielectric constant of 7. Further, it is assumed that the thickness of the liquid crystal layer 103 in the reflective region B is 4.2 μm, and that the dielectric constant thereof is 10 (in a case where the liquid crystal molecules 30a are aligned perpendicular to the substrates). Furthermore, the area of the reflective electrode 120 is defined as Sr, and the area on the side of the control electrode 113, which is facing the reflective electrode 120, is defined as Sg.

In the reflection region B, in a case where the voltage to be applied to the liquid crystal layer 103 is set to be half the voltage to be applied to the control electrode 113, the capacitance between the control electrode 113 and the reflective electrode 120 needs to be equal to the capacitance between the reflective electrode 120 and the common electrode 133. For this reason, the values of Sg, dg, and Sr are needed to be set to satisfy the following equation (1).
7×Sg/dg=10×Sr/4.2 (1)

When the thickness dg of the first insulating film 115 is set to 0.35 μm, the value of Sg/Sr becomes about 0.11 as shown in the following equation (2).
Sg/Sr=10×dg/(4.2×7)=0.11 (2)

Thus, it can be appreciated that the area of the control electrode 113 (i.e., the area of the side facing the reflective electrode 120) should be about one-tenth the area of the reflective electrode 120 so that the voltage, which is half the display voltage to be applied to the control electrode 113, can be applied to the reflective electrode 120.

Hereinafter, a method of manufacturing the semi-transmissive liquid crystal display device of this embodiment will be described with reference to FIGS. 4 to 6.

First, a description will be given of a method of manufacturing the TFT substrate 101.

Initially, a glass substrate 110 is prepared as the base for the TFT substrate 101. A first metal film is then formed on the glass substrate 110. Using photolithography, the first metal film is patterned to form the gate bus lines 111, the auxiliary capacitor electrode 112, the control electrode 113 and the dot patterns 114 at one time. A laminated film of A1 and Ti (aluminum and titanium), for example, is used to form the first metal film. Note that, as a buffer layer, an insulating film may be formed between the glass substrate 110 and the first metal film.

Next, using chemical vapor deposition (CVD) method, the first insulating film (gate insulating film) 115 made of SiO₂ (silicon dioxide), SiN (silicon nitride) or the like is formed on the entire upper surface of the glass substrate 110. Irregularities are formed on the surface of the first insulating film 115, which are corresponding to the shapes of the dot patterns 114. Thereafter, the contact holes are respectively formed in the first transmissive region A1 and the second transmissive region A2 of the first insulating film 115. The contact holes reach the control electrode 113.

Next, using CVD method, a silicon film (an amorphous silicon film or a polysilicon film) is formed on the first insulating film 115. The silicon film is then patterned to form a semiconductor film 116 constituting an active layer of the TFT 118. Thereafter, a channel protection film (not shown) made of SiN is formed on the region constituting a channel of the semiconductor film 116.

Next, a semiconductor film (not shown) having high impurity density which constitutes an ohmic contact layer of the TFT 118 is formed on the entire upper surface of the glass substrate 110. Further, a second metal film is formed on this film. The second metal film is electrically connected to the control electrode 113 via the contact hole formed in the first insulating film 115. The second metal film is formed by sequentially laminating, Ti, Al, and Mo (molybdenum), for example. Irregularities are formed on the surface of the second metal film, which are corresponding to the shapes of the dot patterns 114.

Next, using photolithography, the second metal film and the semiconductor film having high impurity density are patterned to form the data bus lines 117, source electrode 118s of the TFT 118, the drain electrode 118d, the reflective electrode 120 and the metal pads 119a and 119b at one time.

Next, a second insulating film 121 made of, for example, SiN is formed on the entire upper surface of the glass substrate 110. The second insulating film 121 is used to cover the data bus lines 117, the source electrode 118s of the TFT 118, the drain electrode 118d, the reflective electrode 120 and the metal pads 119a and 119b.

Subsequently, using photolithography, the contact hole which reaches the metal pads 119a and 119b is formed in the second insulating film 121. Simultaneously, an aperture 121a is formed in the second insulating film 121 to expose the reflective electrode 120. The second insulating film 121 is etched by using, for example, dry etching employing SF₆/O₂ gas. In this etching process, the second insulating film 121 made of SiN is etched to form the aperture 121a, and at the same time the Mo film constituting the top layer of the reflective electrode 120 is removed to expose the Al film. In this way, the Al film constituting the intermediate layer of the reflective electrode 120 is exposed, and thereby the reflectance of the reflective electrode 120 is increased. Accordingly, it is possible to achieve bright display. The SiN film and the Mo film are easily etched by using dry etching employing SF₆/O₂ gas, however, the Al film is not etched. For this reason, the Al film can be left as an etching stopper. Note that, a Ti film, a MoN film or the like may be used instead of the Mo film.

Next, using sputtering method, an ITO film is formed on the entire upper surface of the glass substrate 110. Using photolithography, the ITO film is then patterned to form the transparent electrodes 122a to 122c. In this case, as shown in FIG. 4, it is preferable to form slits, which determine the alignment directions of liquid crystal molecules, on the edge of each of the transparent electrodes 122a to 122c.

Subsequently, a vertical alignment film (not shown) made of polyimide or the like is formed on the entire upper surface of the glass substrate 110. The vertical alignment film is used to cover the transparent electrodes 122a to 122c. Thus, the TFT substrate 101 is finished.

Next, a description will be given of a method of manufacturing the counter substrate 102. First, a metal film such as Cr (chrome) or the like is formed on a glass substrate 130 (lower surface in FIGS. 5 and 6) which is the base for the counter substrate 102. The metal film is patterned to form a black matrix 131. Thereafter, the color filters 132 (red, green and blue) are formed by use of red, green, and blue photosensitive resins. Note that the black matrix 131 may be formed of black resin, and that two or more of the different color filters 132 may be laminated to form the black matrix 131.

Next, using sputtering method, the common electrode 133 made of ITO is formed on the entire upper surface of the glass substrate 130. Thereafter, photosensitive resin is coated on the common electrode 133, and then the glass substrate 130 is subject to an exposure process and a development process. Thereby, the alignment regulating protrusions 134 are formed. The alignment regulating protrusions 134 are formed on areas of the substrate 130, which are corresponding to the center portions of the transmissive regions A1 and A2 and the reflective region B, respectively.

Next, the vertical alignment film (not shown) is formed by coating, for example, polyimide on the surfaces of the common electrode 133 and the alignment regulating protrusions 134. In this way, the counter substrate 102 is finished.

After forming the TFT substrate 101 and the counter substrate 102 as described above, a liquid crystal panel is formed by sealing liquid crystal having negative dielectric anisotropy between the TFT substrate 101 and the counter substrate 102 by use of either vacuum filling method or dispensing method. Thereafter, circularly polarizing plates are placed on both sides of the liquid crystal panel, and a backlight is mounted thereto. In this way, the liquid crystal display device of this embodiment is finished.

As described above, in this embodiment, the control electrode 113 and the dot patterns 114 are formed concurrently with the gate bus lines 111, the reflective electrode 120 is formed concurrently with the data bus lines 117, and the aperture 121a from which the reflective electrode 120 (the aluminum film) is exposed is formed concurrently with the contact hole which connects the transparent electrode 122a to the source electrode 118s of the TFT 118. Accordingly, it is possible to manufacture a semi-transmissive liquid crystal display device through substantially the same processes as those through which a typical transmissive liquid crystal display device is manufactured. Therefore, the effect that the cost of manufacturing semi-transmissive liquid crystal display devices is reduced can be brought about.

### Second Embodiment

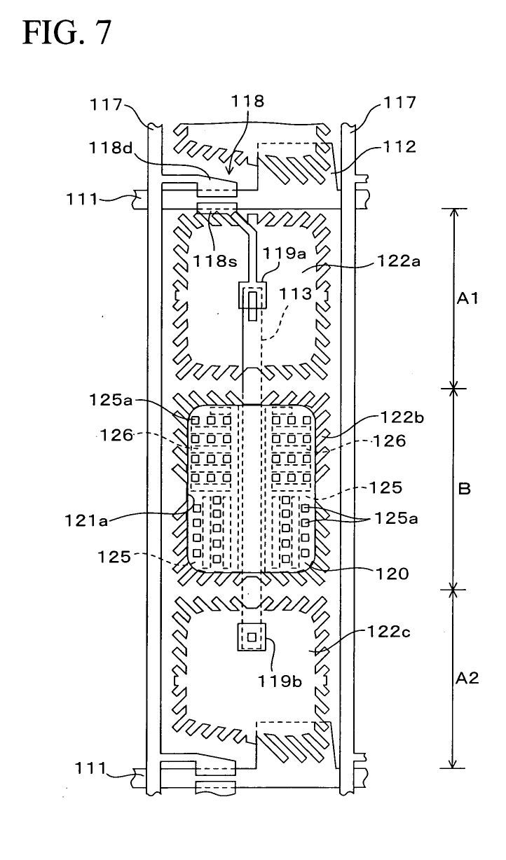

FIG. 7 is a plan view showing a semi-transmissive liquid crystal display device of a second embodiment of the present invention. The difference between the semi-transmissive liquid crystal display device of the second embodiment and the semi-transmissive liquid crystal display device of the first embodiment is the structure for forming irregularities on the surface of the reflective electrode. Other structures are basically the same as those of the semi-transmissive liquid crystal display device of the first embodiment. Accordingly, in FIG. 7, the same components as those in FIG. 4 are denoted by the same reference numerals and a detailed description thereof will be omitted.

In this embodiment, concurrent with formation of the control electrode 113, for example, a metal pattern 125 having multiple rectangular holes 125a is formed on left and right side portions of the control electrode 113 within the reflective region B. In addition, when the semiconductor film 116 constituting the active layer of the TFT 118 is formed, multiple rectangular irregular patterns 126 made of a semiconductor film are formed under the reflective electrode 120. Moreover, in the etching step of forming the contact holes in the second insulating film 121, a plurality of holes (irregular patterns) is formed on a portion of the second insulating film 121, which is positioned under the reflective electrode 120.

In this embodiment, irregular patterns are formed on the metal film, on the semiconductor film and on the insulating film, which are positioned under the reflective electrode 120 as described above. Accordingly, fine and complicated shapes can be achieved for the irregularities formed on the surface of the reflective electrode 120 as compared to the first embodiment.

Note that, in the first and second embodiments, the case has been described in which one picture element region is divided into three regions (i.e., the first and second transmissive regions A1 and A2 and the reflective region B), however, the ratio of the number of the transmissive region to the number of the reflective region is not limited to those in the first and second embodiments and may be set depending on the required specification.

### Third Embodiment

A third embodiment will be described below.

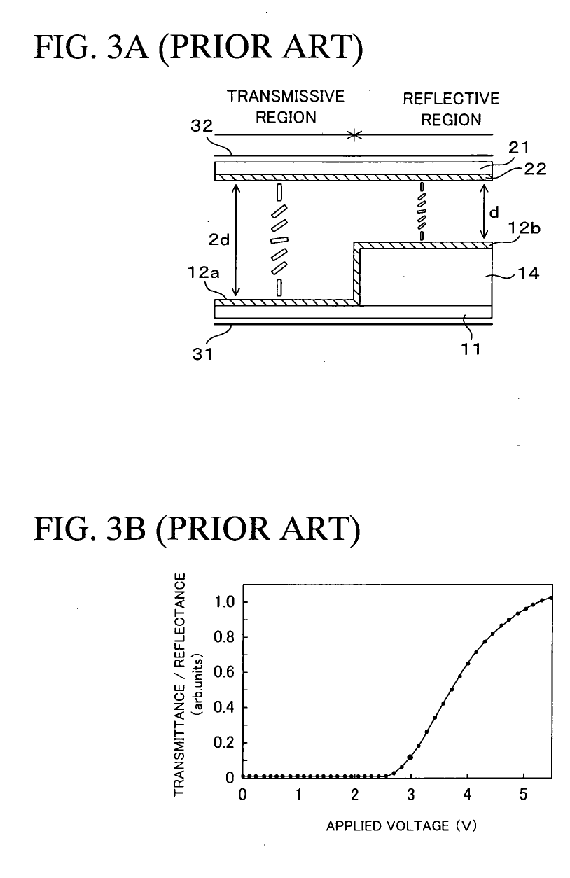

As described above, the semi-transmissive liquid crystal display device shown in FIG. 3A has following drawbacks. Specifically, irregularity occurs in the alignment of the liquid crystal molecules at irregular portions to cause the optical losses. In addition, impact and the like cause the bead-shaped spacer to move from top to bottom of the irregular portion and the cell thickness is changed. In this connection, it is conceivable that a dielectric film (insulating film) is formed on the reflective electrode to eliminate the irregular portions.

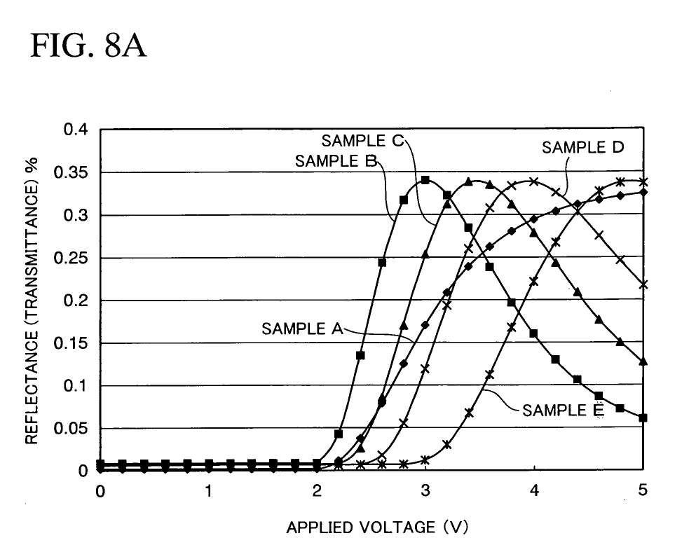

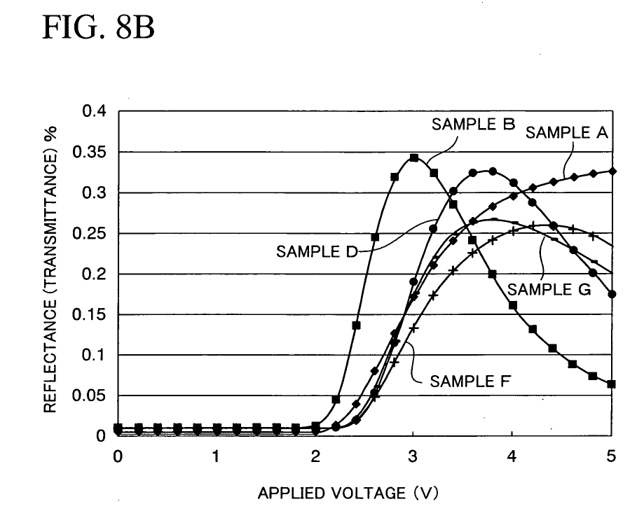

FIG. 8A is a graph showing the results of simulation calculations performed for T-V characteristic in the transmissive region and for R-V characteristic in the reflective region of a VA (vertical alignment) mode semi-transmissive liquid crystal display device having 4 μm cell thickness in the transmissive region, where the horizontal axis represents the applied voltage and the longitudinal axis represents reflectance and transmittance. In FIG. 8A, sample A denotes T-V characteristic in the transmissive region, and sample B denotes R-V characteristic in a case where a dielectric film is not formed on the reflective electrode. Furthermore, sample C denotes R-V characteristic in a case where a dielectric film with a thickness of 500 nm is formed on the reflective electrode, sample D denotes R-V characteristic in a case where a dielectric film with a thickness of 1000 nm is formed on the reflective electrode, and sample F denotes R-V characteristic in a case where a dielectric film with a thickness of 2000 nm is formed on the reflective electrode. Note that the relative dielectric constant E of the dielectric film is set to 4 (ε=4).

As can be seen from FIG. 8A, the change in the thickness of the dielectric film formed on the reflective electrode leads to change in the threshold of the R-V characteristic and in the slope of the curve thereof. In a sample in which a dielectric film with a thickness of 1000 nm is formed on the reflective electrode (i.e., sample D), the threshold of R-V characteristic becomes substantially equal to that of T-V characteristic, as well as the reflectance thereof is increased with an increasing applied voltage in a range of the threshold voltage to approximately 4V. Thus, it can be appreciated that the sample D satisfies minimum requirements needed for a semi-transmissive liquid crystal display device. However, also in this case the difference between the curves of T-V characteristic and R-V characteristic is comparatively large. Therefore, further improvements are requested.

As can be seen from FIG. 8A, the threshold of the R-V characteristic and the slope of the curve thereof change depending on the thickness of the dielectric film formed on the reflective electrode. Accordingly, in this embodiment, it is assumed that the reflective region is further divided into a plurality of regions and that the thickness of the dielectric film in each region is different from one another. When the reflective region is divided into a plurality of regions each having a dielectric film of which thickness is different from one another, R-V characteristic in the entire reflective region becomes one obtained by combining R-V characteristic in each region. Therefore, R-V characteristic can be made further closer to the T-V characteristic in the transmissive region.

FIG. 8B is a graph showing the results of simulation calculations performed for T-V characteristic in the transmissive region and for R-V characteristic in the reflective region of the VA (vertical alignment) mode semi-transmissive liquid crystal display device having 4 μm cell thickness in the transmissive region, where the horizontal axis represents the applied voltage and the longitudinal axis represents reflectance and transmittance. In FIG. 8B, sample A denotes T-V characteristic in the transmissive region, and sample B denotes R-V characteristic in a case where a dielectric film is not formed on the reflective electrode. Furthermore, sample D denotes R-V characteristic in a case where a dielectric film with a thickness of 1000 nm is formed on the entire surface of the reflective electrode, sample F denotes R-V characteristic in a case where the reflective region is divided into a first region in which a dielectric film with a thickness of 500 nm is formed and a second region in which the dielectric film with a thickness of 2000 nm is formed (the area ratio between the first and second regions is: 1:1). In addition, sample G denotes R-V characteristic in a case where the reflective region is divided into a first region in which the dielectric film is not formed, a second region in which a dielectric film with a thickness 500 nm is formed, and a third region in which a dielectric film with a thickness of 2000 nm is formed (the area ratio among the first to third regions is: 1:1:1). Note that the relative dielectric constant ε of the dielectric film is set to 4 (ε=4).

As can be seen from FIG. 8B, the reflective region is divided into a plurality of regions each having a dielectric film of which thickness is different from one another, and thereby the control ranges of the threshold of R-V characteristic as well as the slope of the curve thereof are extended. Therefore, R-V characteristic in the reflective region can be made further closer to the T-V characteristic in the transmissive region.

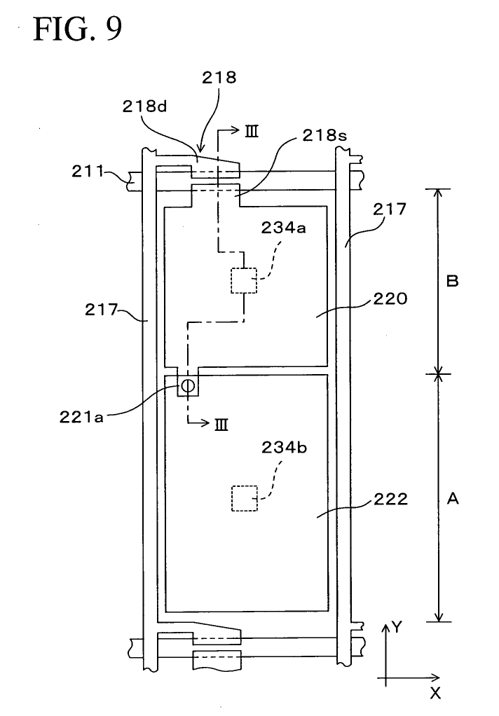

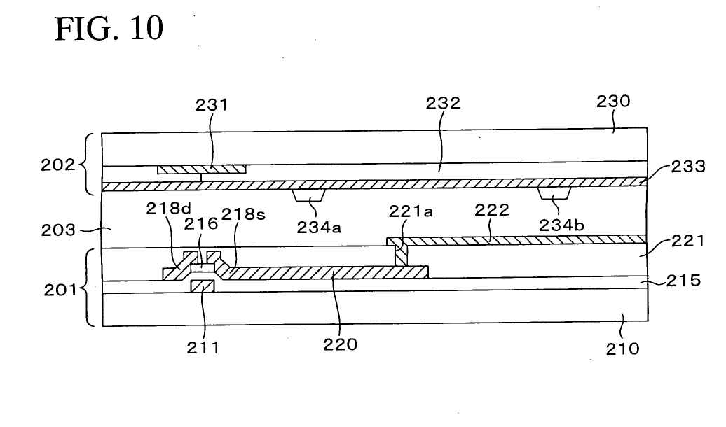

FIG. 9 is a plan view showing a semi-transmissive liquid crystal display device of the third embodiment of the present invention. FIG. 10 is a cross-sectional view taken along the III-III line in FIG. 9. Note that FIG. 9 shows the configuration of one picture element.

As shown in FIGS. 9 and 10, the semi-transmissive liquid crystal display device of this embodiment includes: a TFT substrate 201; a counter substrate 202; and a liquid crystal layer 203 formed of vertical alignment-type liquid crystals (liquid crystals having negative dielectric anisotropy) sealed between the TFT substrate 201 and the counter substrate 202. A first circularly polarizing plate (not shown) is placed under the TFT substrate 201. A second circularly polarizing plate (not shown) is placed on the counter substrate 202. One of the first and second circularly polarizing plates is a right-hand circularly polarizing plate. The other one is a left-hand circularly polarizing plate. These first and second circularly polarizing plates are placed so that the optical axes are orthogonal to each other. In addition, a backlight (not shown) is placed under the TFT substrate 201.

As shown in FIG. 9, in the TFT substrate 201, a plurality of gate bus lines 211 extending in the horizontal direction (X direction) and a plurality of data bus lines 217 extending in the vertical direction (Y direction) are formed. The gate bus lines 211 and the data bus lines 217 partition the TFT substrate 201 and thereby rectangular regions are formed. Each of the rectangular region is a picture element region.

In this embodiment, one picture element is divided into a transmissive region A in which a transparent electrode 222 is placed and a reflective region B in which a reflective electrode 220 is placed. Moreover, one TFT 218 is formed on one picture element region. The TFT 218 uses a part of the gate bus line 211 as a gate electrode. A source electrode 218s and a drain electrode 218d are placed with the gate bus line 211 interposed therebetween.

As shown in FIG. 9, the drain electrode 218d is connected to the data bus line 217, and the source electrode 218s is formed integrally with the reflective electrode 220. In addition, the transparent electrode 222 is electrically connected to the reflective electrode 220 via a contact hole 221a. At least the surface of the reflective electrode 220 is formed of metal having high reflectance such as Al, and the transparent electrode 222 is formed of a transparent conductive material such as ITO.

As shown in FIG. 10, the reflective electrode 220 is formed on a layer different from a layer in which the transparent electrode 222 is formed. Specifically, the reflective electrode 220 is formed under a dielectric film 221 made of resin or the like, and the transparent electrode 222 is formed over the dielectric film 221.

Meanwhile, a black matrix (light blocking film) 231, a color filter 232, a common electrode 233 and dielectric films 234a and 234b are formed on the counter substrate 202. The black matrix 231 is placed opposite to the gate bus line 211, to the data bus line 217, and to the TFT 218, which are formed on the TFT substrate 201.

The color filters 232 are classified into three types of red (R), green (G), and blue (B). A color filter of any one color among these colors is placed in one picture element.

The common electrode 233 is made of a transparent conductive material such as ITO. The dielectric film 234a is placed on the center portion of the reflective region B, and the dielectric film 234b is formed on the center portion of the transmissive region A. The dielectric films 234a and 234b are formed of, for example, transparent resin. As will be described later, the dielectric films 234a and 234b have, as alignment regulating members, a function of regulating the alignment directions of liquid crystal molecules when a voltage is applied. In addition, the dielectric film 234a placed on the reflective region B also has a function of controlling R-V characteristic in the reflective region.

In the semi-transmissive liquid crystal display device of this embodiment constituted as described above, when a voltage is not applied to the reflective electrode 220 and to the transparent electrode 222, liquid crystal molecules are aligned substantially perpendicular to the surfaces of the substrates. In this case, in the transmissive regions A, the light emitted from the backlight passes through the first circularly polarizing plate and the transparent electrode 222, and then enters the liquid crystal layer 203 and passes through the liquid crystal layer 203 without changing its polarization direction. Thereafter, the light passage is blocked by the second circularly polarizing plate. Specifically, black is displayed in the transmissive region A. Moreover, in the reflective region B, the light which comes from above the liquid crystal panel passes through the second circularly polarizing plate and enters the liquid crystal layer 203. The light in the liquid crystal layer 203 is then reflected by the reflective electrode 220 to travel in the upward direction, and is blocked by the second circularly polarizing plate. Accordingly, black is also displayed in the reflective region B.

If a scanning signal is supplied to the gate bus line 211 while a display voltage is being applied to the data bus line 217, the TFT 218 is turned on, and thereby a display voltage is applied to the reflective electrode 220 and to the transparent electrode 222. In this way, the liquid crystal molecules are aligned in an oblique direction relative to the surfaces of the substrates, and are aligned in a radial direction centered around the dielectric films 234a and 234b when viewed from above the liquid crystal panel. In this case, in the transmissive region A, the light emitted from the backlight passes through the first circularly polarizing plate and the transparent electrode 222, and then enters the liquid crystal layer 203. In the liquid crystal layer 203, the polarization direction of the light is changed, and thereby the light can pass through the second circularly polarizing plate. Specifically, a bright color is displayed in the transmissive region A. In the reflective region B, light comes from above the liquid crystal panel, passes through the second circularly polarizing plate, enters the liquid crystal layer 203, and is reflected by the reflective electrode 220 to travel in the upward direction. Here, in similar way, the polarization direction of the light is changed while passing through the liquid crystal layer 203 and thereby the light can pass through the second circularly polarizing plate.

In this embodiment, the dielectric films 221 and 234a are interposed between the reflective electrode 220 and the common electrode 233. Moreover, the thickness of the liquid crystal layer is different between a portion formed with the dielectric film 234a and the periphery thereof. In other words, the reflective region B is divided into two regions, where the thickness of the liquid crystal layer is different from each other. Accordingly, R-V characteristic in the reflective region B can be made closer to the T-V characteristic in the transmissive region A as described above (see FIG. 8B), thereby making it possible to obtain an excellent display quality when the liquid crystal display device of this embodiment is used either as a transmissive liquid crystal display device or as a reflective liquid crystal display device.

Moreover, in this embodiment, the surface of the TFT substrate 201 becomes almost smooth. For this reason, the variance in the cell thickness can be avoided, which is caused by the movement of the bead-shaped spacers because of impact and the like.

Hereinafter, a description will be given of a method of manufacturing the semi-transmissive liquid crystal display device of this embodiment with reference to FIGS. 9 and 10. First, a method of manufacturing the TFT 201 will be described.

Initially, a glass substrate 210 is prepared as the base for the TFT substrate 201. A first metal film is then formed on the glass substrate 210. Using photolithography, the first metal film is patterned to form the gate bus lines 211. A laminated film of Al and Ti, for example, is used to form the first metal film.

Next, using CVD method, an insulating film (gate insulating film) 215 made of SiN or the like is formed on the entire upper surface of the glass substrate 210. A semiconductor film 216 constituting an active layer of the TFT 218 is formed on a predetermined region of the insulating film 215. Thereafter, a channel protection film (not shown) made of SiN is formed on the region constituting a channel of the semiconductor film 216.

Next, a semiconductor film (not shown) having high impurity density which constitutes an ohmic contact layer of the TFT 218 is formed on the entire upper surface of the glass substrate 210. Further, a second metal film is formed on this film. The second metal film is made of, for example, a laminated film of Ti and Al.

Next, using photolithography, the second metal film and the semiconductor film having high impurity density are patterned to form the data bus lines 217, source electrode 218s, the drain electrode 218d and the reflective electrode 220. Here, as shown in FIG. 9, the source electrode 218s is formed integrally with the reflective electrode 220.

Next, the dielectric film 221 is formed by coating photosensitive resin having relative dielectric constant ε, for example, of 4 on the entire upper surface of the glass substrate 210. The dielectric film 221 is then subject to an exposure process and a development process, thereby forming the contact hole 221a which reaches the reflective electrode 220.

Subsequently, using sputtering method, an ITO film is formed on the entire upper surface of the glass substrate 210. Using photolithography, the ITO film is then patterned to form the transparent electrode 222. Thereafter, a vertical alignment film (not shown) made of polyimide or the like is formed on the entire upper surface of the glass substrate 210. Thus, the TFT substrate 201 is finished.

Next, a method of manufacturing the counter substrate 202 will be described. First, a metal film such as Cr or the like is formed on a glass substrate 230 (lower surface in FIG. 10) which is the base for the counter substrate 202. The metal film is patterned to form the black matrix 231. Thereafter, the color filters 232 (red, green and blue) are respectively formed on a predetermined picture element regions using red, green and blue photosensitive resins.

Next, using sputtering method, the common electrode 233 made of ITO or the like is formed on the entire upper surface of the glass substrate 230. Thereafter, photosensitive resin having relative dielectric constant ε of, for example, 4 is coated on the common electrode 233, and then the glass substrate 230 is subject to an exposure process and a development process. Thereby, the dielectric films 234a and 234b are formed. Subsequently, a vertical alignment film (not shown) made of polyimide or the like is formed on the surfaces of the common electrode 233 and the dielectric electrodes 234a and 234b. Thus, the counter substrate 202 is finished.

After forming the TFT substrate 201 and the counter substrate 202 as described above, bead-shaped spacers are sprayed on one of the substrates. Then, using a sealing material, the TFT substrate and the counter substrate 202 are bonded together. A vertical alignment-type liquid crystal is then sealed between the TFT substrate 201 and the counter substrate 202. Thereby, a liquid crystal panel is formed. Thereafter, circularly polarizing plates are placed on both sides of the liquid crystal panel, and a backlight is mounted thereto. In this way, the semi-transmissive liquid crystal display device of this embodiment is finished.

According to the above-described manufacturing method, a semi-transmissive liquid crystal display device can comparatively easily be manufactured which is capable of exhibiting an excellent display quality even when used either as a transmissive liquid crystal display device or as a reflective liquid crystal display device.

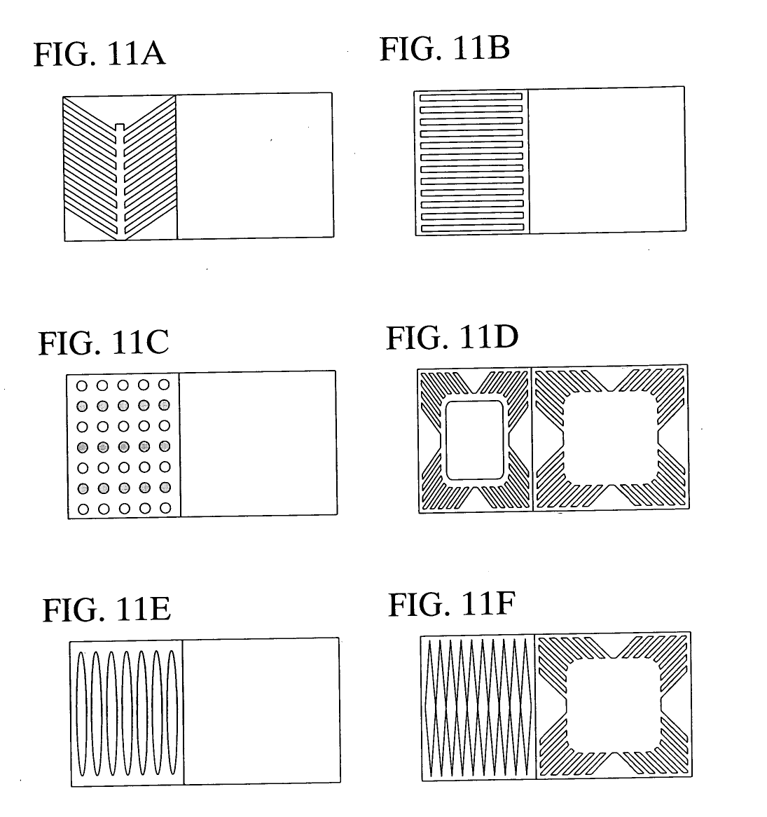

Note that, the description has been given of the case where the planar shapes of the dielectric films 234a and 234b are rectangular, however, the shapes of the dielectric films 234a and 234b may be as shown in FIGS. 11A to 11F. FIG. 11A shows an example in which a plurality of bar-shaped dielectric films extending in oblique directions is formed on the surface of the reflective region of the counter substrate so as to be symmetrical. In this case, when a voltage is applied, the liquid crystal molecules are aligned in the directions in which the dielectric films extend. Moreover, in the example shown in FIG. 11A, the rubbing treatment is performed for the alignment film in the transmissive region, and the liquid crystal molecules are aligned along the rubbing direction when a voltage is applied.

FIG. 11B shows an example in which a plurality of bar-shaped dielectric films extending in one direction is formed on the surface of the reflective region of the counter substrate so as to be parallel with one another. Also in this liquid crystal display device, the alignment direction of the liquid crystal molecules in the transmissive region is regulated by performing the rubbing treatment.

FIG. 11C shows an example in which two types of circle-shaped dielectric films, which have different dielectric constants from each other, are formed on the reflective region at predetermined intervals. Also in this liquid crystal display device, alignment direction of the liquid crystal molecules in the transmissive region is regulated by performing the rubbing treatment.

FIG. 11D shows an example in which dielectric films are radially formed on both the reflective region and the transmissive region. FIG. 11E shows an example in which a plurality of ellipse-shaped dielectric films is formed on the reflective region at predetermined intervals. Furthermore, FIG. 11F shows an example in which a plurality of rhombus-shaped dielectric films is formed on the reflective region at predetermined intervals, and in which dielectric films are radially formed on the transmissive region.

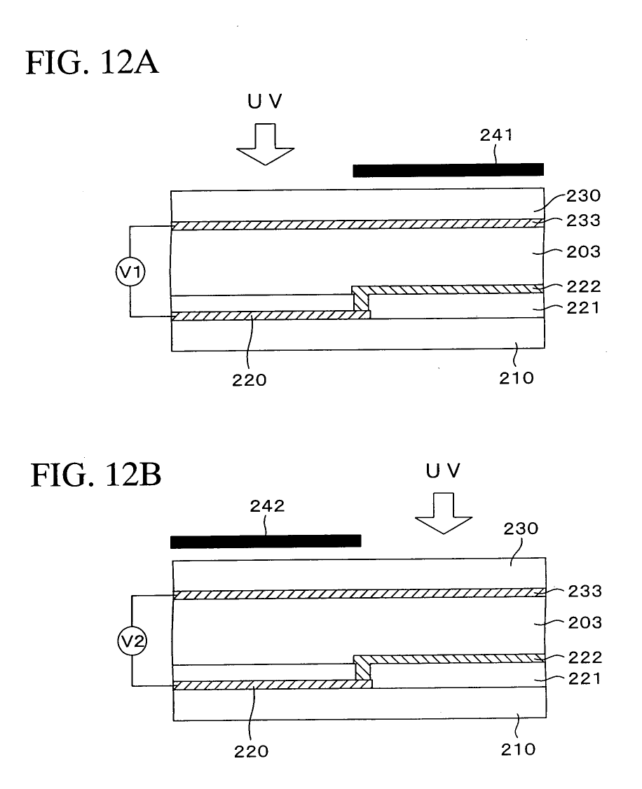

In addition, for enhanced response characteristic in the liquid crystal display device, polymer for determining the alignment direction of the liquid crystal molecules may be formed in the liquid crystal layer 203. For example, ultraviolet (UV) curable monomer is previously added in the liquid crystal. As shown schematically in FIG. 12A, the voltage V1 is then applied between the reflective electrode 220 and the common electrode 233 to align the liquid crystal molecules in the reflective region in the predetermined direction, and ultraviolet light is irradiated on the substrate after covering the transmissive region with a mask 241, thereby polymerizing monomer in the reflective region to form polymer. Thereafter, as shown schematically in FIG. 12B, the voltage V2 is then applied between the transparent electrode 222 and the common electrode 233 to align the liquid crystal molecules in the transmissive region in the predetermined direction, and ultraviolet light is irradiated on the substrate after covering the reflective region with a mask 242, thereby polymerizing monomer in the transmissive region to form polymer.

Moreover, in the above-described embodiment, the case has been described in which the reflective region is divided into a plurality of regions each having different dielectric film thickness from one another. However, similar effect can be obtained even when either the relative dielectric constant or the density of the dielectric film in each region is set to be different from one another.

### Fourth Embodiment

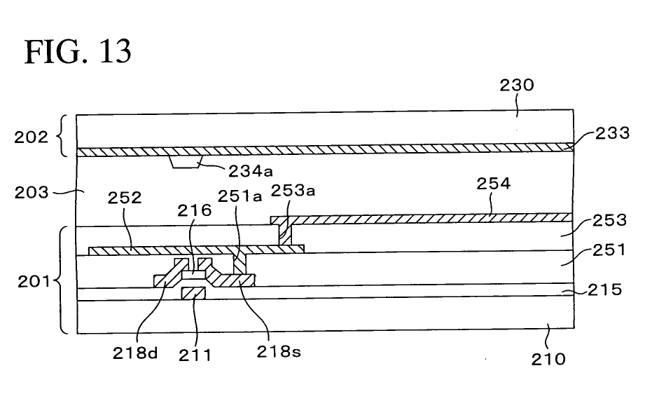

FIG. 13 is a cross-sectional view showing a semi-transmissive liquid crystal display device of a fourth embodiment of the present invention. Note that, in FIG. 13, the same components as those in FIG. 10 are denoted by the same reference numerals.

In this embodiment, the gate bus lines 211 are formed on the glass substrate 210 which is the base for the TFT substrate 202, and the first insulating film 215 is formed thereon. A TFT constituted by the semiconductor film 216, source electrode 218s and the drain electrode 218d, and data bus lines (not shown) are then formed on the first insulating film 215. Thereafter, a second insulating film 251 made of SiO₂, SiN, resin or the like is formed, and thereby the TFT and the data bus lines are covered.

Next, after forming a contact hole 251a, which reaches the source electrode 218c, in the second insulating film 251, a metal film (a laminated film of Ti and Al, for example) is formed on the entire surface of the second insulating film 251. Using photolithography, the metal film is then patterned to form a reflective electrode 252. The reflective electrode 252 is electrically connected to the source electrode 218s of the TFT via the contact hole 251a.

Next, red photosensitive resin is coated on the entire upper surface of the glass substrate 210, and an exposure process and a development process are performed. In this way, a red color filter 253 is formed on the red picture element region. Here, a contact hole 253a which reaches the reflective electrode 252 is formed in the color filter 253. In similar way, green and blue color filters 253 are formed on the green and blue picture element regions, respectively.

Next, an ITO film is formed on the color filters 253, and the ITO film is then patterned to form a transparent electrode 254. The transparent electrode 254 is electrically connected to the reflective electrode 252 via the contact hole 253a. Subsequently, polyimide or the like is coated on the entire upper surface of the glass substrate 210 to form a vertical alignment film (not shown).

Meanwhile, the common electrode 233 made of a transparent conductive material such as ITO or the like is formed on the glass substrate 230 (lower surface in FIG. 13) which is the base for the counter substrate 202. The dielectric film 234a is then formed on a predetermined region of the common electrode 233. Thereafter, a vertical alignment film is formed which covers the surfaces of the common electrode 233 and the dielectric film 234a.

In this embodiment, similar to the third embodiment, two dielectric films (the dielectric film 234a and the color filter 253) are interposed between the reflective electrode 252 and the common electrode 233, and the thickness of the liquid crystal layer is different between a portion formed with the dielectric film 234a and the periphery thereof. Accordingly, R-V characteristic in the reflective region can be made closer to T-V characteristic in the transmissive region, thereby making it possible to obtain an excellent display quality when the liquid crystal display device of this embodiment is used either as a transmissive liquid crystal display device or as a reflective liquid crystal display device. In addition, the surface of the TFT substrate 201 becomes almost smooth. Thereby, the movement of the bead-shaped spacers, which is caused by impact and the like, can be avoided.

Furthermore, in this embodiment, the reflective electrode 255 is formed on both the TFT and the gate bus lines 211 and thereby the aperture ratio is increased, providing the advantage that bright display can be achieved.

Note that, although not shown in FIG. 13, a general liquid crystal display device includes auxiliary capacitor bus lines formed in parallel with the gate bus lines. It is preferable that the auxiliary capacitor bus lines be also formed under the reflective electrode 252. Moreover, also in this embodiment, the dielectric film for controlling R-V characteristic in the reflective region may be formed so as to have shapes shown in FIGS. 11A to 11F.

### Fifth Embodiment

A fifth embodiment of the present invention will be described below.

It can be learned that, in the above-described embodiment 3, T-V characteristic substantially matches R-V characteristic when the white voltage is set to around 4V as shown in FIG. 8B and therefore the semi-transmissive liquid crystal display device having an excellent display quality can be obtained. However, when a voltage higher than 4V is applied, brightness in the reflective region is reduced. For this reason, the white voltage is limited to around 4V as described above, possibly resulting insufficient brightness or requiring a strong backlight.

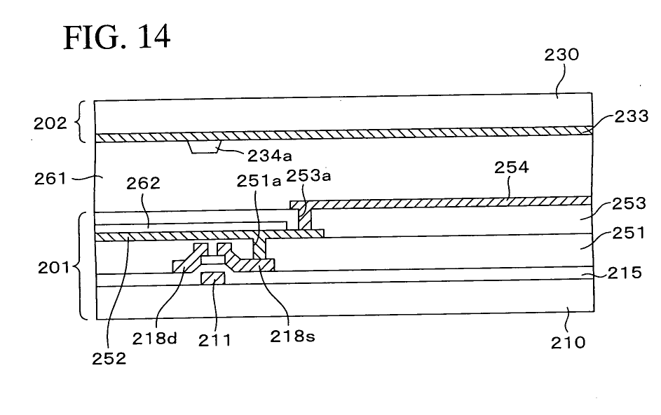

FIG. 14 is a cross-sectional view showing a semi-transmissive liquid crystal display device of the fifth embodiment of the present invention. In FIG. 14, the same components as those in FIG. 13 are denoted by the same reference numerals and a detailed description thereof will be omitted.

In the semi-transmissive liquid crystal display device of this embodiment, a liquid crystal layer 261 formed of a chiral nematic liquid crystal having negative dielectric anisotropy is sealed between the TFT substrate 201 and the counter substrate 202. As shown in FIG. 14, a λ/4 film 262 is formed on the reflective electrode 252 of the TFT substrate 201. The λ/4 film 262 has a retardation and serves as a λ/4 plate for visible light. The λ/4 film 262 is formed as follows: for example, subjecting the surface of the reflective electrode 252 to the rubbing treatment; coating liquid crystalline acrylate monomer thereon; and subsequently curing the monomer.

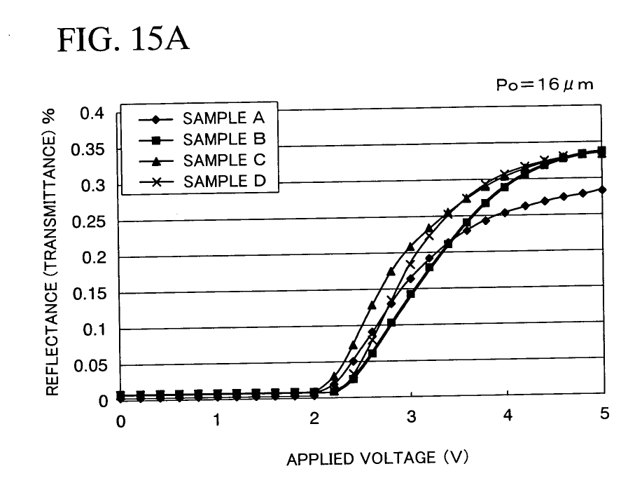

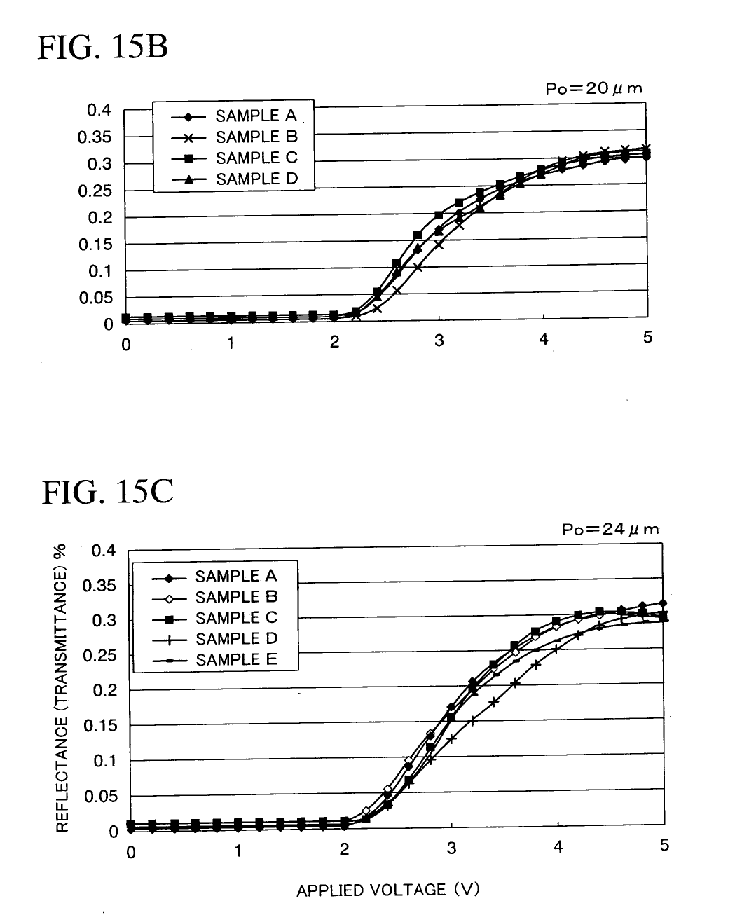

FIG. 15A is a graph showing the results of simulation calculations performed for T-V characteristic in the transmissive region and for R-V characteristic in the reflective region of a VA mode semi-transmissive liquid crystal display device having the structure shown in FIG. 14, where the horizontal axis represents the applied voltage and the longitudinal axis represents reflectance and transmittance. Note that the cell thickness of the transmissive region is set to 4 μm, and the chiral pitch Po is set to 16 μm (4 times the cell thickness).

In FIG. 15A, sample A denotes T-V characteristic in the transmissive region, sample B denotes R-V characteristic in a case where the reflective region is divided into a first region in which a dielectric film with a thickness of 500 nm is formed, and a second region in which the dielectric film with a thickness of 2000 nm is formed (the area ratio between the first and second regions is: 1:1). Further, sample C denotes R-V characteristic in a case where the reflective region is divided into a first region where the dielectric film is not formed, a second region in which a dielectric film with a thickness of 500 nm is formed, and a third region in which a dielectric film with a thickness of 2000 nm is formed (the area ratio among the first to third regions is 1:1:1). Furthermore, sample D denotes R-V characteristic in a case where the reflective region is divided into a first region in which a dielectric film with a thickness of 500 nm is formed and a second region in which a dielectric film with a thickness of 2000 nm is formed (the area ratio between the first and second regions is 2:1).

FIG. 15B is a graph showing the results of simulation calculations performed for T-V characteristic in the transmissive region and for R-V characteristic in the reflective region of the VA mode semi-transmissive liquid crystal display device having the structure shown in FIG. 14, where the horizontal axis represents the applied voltage and the longitudinal axis represents reflectance and transmittance. Note that the cell thickness of the transmissive region is set to 4 μm, and the chiral pitch Po is set to 20 μm (5 times the cell thickness).

In FIG. 15B, sample A denotes T-V characteristic in the transmissive region, sample B denotes R-V characteristic in a case where the reflective region is divided into a first region in which a dielectric film with a thickness of 500 nm is formed, and a second region in which the dielectric film with a thickness of 2000 nm is formed (the area ratio between the first and second regions is: 1:1). Further, sample C denotes R-V characteristic in a case where the reflective region is divided into a first region in which a dielectric film with a thickness of 250 nm is formed and a second region in which a dielectric film with a thickness of 2000 nm is formed (the area ratio between the first and second regions is 3:2). Furthermore, sample D denotes R-V characteristic in a case where the reflective region is divided into a first region in which a dielectric film with a thickness of 250 nm is formed and a second region in which a dielectric film with a thickness of 2000 nm is formed (the area ratio between the first and second regions is 1:1).

FIG. 15C is a graph showing the results of simulation calculations performed for T-V characteristic in the transmissive region and for R-V characteristic in the reflective region of the VA mode semi-transmissive liquid crystal display device having the structure shown in FIG. 14, where the horizontal axis represents the applied voltage and the longitudinal axis represents reflectance and transmittance. Note that the cell thickness of the transmissive region is set to 4 μm and the chiral pitch Po is set to 24 μm (6 times the cell thickness).

In FIG. 15C, sample A denotes T-V characteristic in the transmissive region, sample B denotes R-V characteristic in a case where the reflective region is divided into a first region where a dielectric film is not formed, a second region in which a dielectric film with a thickness of 1000 nm is formed and a third region in which a dielectric film with a thickness of 2000 nm is formed (the area ratio among the first to third regions is 1:1:1). Further, sample C denotes R-V characteristic in a case where the reflective region is divided into a first region where a dielectric film with a thickness of 250 nm is formed, a second region in which a dielectric film with a thickness of 1000 nm is formed, and a third region in which a dielectric film with a thickness of 2000 nm is formed (the area ratio among the first to third regions is 1:1:1). Furthermore, sample D denotes R-V characteristic in a case where the reflective region is divided into a first region in which a dielectric film with a thickness of 250 nm is formed, a second region in which a dielectric film with a thickness of 1500 nm is formed and a third region in which a dielectric film with a thickness of 2500 nm is formed (the area ratio among the first to third regions is 1:1:1). Finally sample E represents R-V characteristics such that reflective region is divided into three regions of which the first region's dielectric film has the thickness of 250 nm, the second region's 1000 nm, and the third region's 2500 nm, and whose area ratio is 1:1:1.

As can be seen from FIGS. 15A to 15C, when the chiral pitch is set to 16 μm (4 times the cell thickness), T-V characteristic in the transmissive region and R-V characteristic in the reflective region cannot be matched. However, when a chiral nematic liquid crystal having the chiral pitch of 20 μm (5 times the cell thickness) or 24 μm (6 times the cell thickness) is used, T-V characteristic in the transmissive region and R-V characteristic in the reflective region can be substantially matched. Thus, it is made possible to obtain an excellent display quality when the liquid crystal display device is used either as the transmissive liquid crystal display device or as the reflective liquid crystal display device.

Note that, in the above-described embodiments 1 to 5, examples have been described in which the VA mode (including MVA mode) semi-transmissive liquid crystal display device is applied to the present invention, however the semi-transmissive liquid crystal display device of the present invention is not limited to the VA mode semi-transmissive liquid crystal display device.

What is claimed is:

1. A semi-transmissive liquid crystal display device which is constituted of first and second substrates placed so as to face each other and a liquid crystal sealed between the first and second substrates, and which includes a transmissive region and a reflective region in one picture element region,
wherein the first substrate includes a TFT, a transparent electrode which is placed in the transmissive region and receives a display voltage via the TFT, a control electrode which is placed in the reflective region and receives the display voltage via the TFT, and a reflective electrode which is placed in the reflective region and is capacitively coupled to the control electrode, and
wherein the second substrate includes a common electrode facing both the transparent electrode and the reflective electrode.

2. The semi-transmissive liquid crystal display device according to claim 1,
wherein the control electrode is formed in the same layer as a gate electrode of the TFT, the reflective electrode is formed in the same layer as source/drain electrodes of the TFT, and an insulating layer formed in the same layer as a gate insulating film of the TFT is interposed between the control electrode and the reflective electrode.

3. The semi-transmissive liquid crystal display device according to claim 1,
wherein a transparent conductive film made of the same material as the transparent electrode is formed on the reflective electrode.

4. The semi-transmissive liquid crystal display device according to claim 1,
wherein irregularities, which are corresponding to the shapes of irregular patterns formed in a layer under the reflective electrode, are formed on the surface of the reflective electrode.

5. The semi-transmissive liquid crystal display device according to claim 1,
wherein the irregular patterns are formed in one or more of the following layers: the layer in which the gate electrode of the TFT is formed; a layer in which an active layer of the TFT is formed; and a layer in which the source/drain electrodes of the TFT are formed.

6. The semi-transmissive liquid crystal display device according to claim 1, further comprising an auxiliary capacitor electrode having a Cs-on-Gate structure, which is connected to a gate electrode of a TFT of another picture element and which forms an auxiliary capacitance between the auxiliary capacitor electrode and the transparent electrode.

7. A method of manufacturing a semi-transmissive liquid crystal display device, comprising the steps of:
forming a first metal film on a first substrate;
forming a gate bus line and a control electrode by patterning the first metal film;
forming a first insulating film on an entire upper surface of the first substrate;
forming a first contact hole which reaches the control electrode in the first insulating film;
forming a semiconductor film constituting an active layer of a TFT on a predetermined region of the first insulating film;
forming a second metal film on the first insulating film;
forming, by patterning the second metal film, a data bus line, source/drain electrodes of the TFT, metal pad electrically connected to the control electrode via the first contact hole, and a reflective electrode capacitively coupled to the control electrode via the first insulating film;
forming a second insulating film on the entire upper surface of the first substrate;
forming a second contact hole, which reaches the metal pad, as well as an aperture from which the reflective electrode is exposed in the second insulating film;
forming a transparent conductive film on the entire upper surface of the first substrate;
forming a transparent electrode by patterning the transparent conductive film; and
placing a second substrate including a common electrode so as to face the first substrate, and sealing a liquid crystal between the first substrate and the second substrate.

8. The method of manufacturing a semi-transmissive liquid crystal display device according to claim 7,
wherein, using the first metal film, irregular patterns are formed under a region in which the reflective electrode is formed.

9. The method of manufacturing a semi-transmissive liquid crystal display device according to claim 7,
wherein a second transparent electrode for covering a surface of the reflective electrode is formed by means of the transparent conductive film.

10. The method of manufacturing a semi-transmissive liquid crystal display device according to claim 7,
wherein, using the first metal film, an auxiliary capacitor electrode is formed under a region in which the transparent electrode is formed.

11. The method of manufacturing a semi-transmissive liquid crystal display device according to claim 7,
wherein the second metal film is a laminated film obtained by laminating a metal film on a Al film, the metal film essentially containing any one of Mo and Ti.

12. The method of manufacturing a semi-transmissive liquid crystal display device according to claim 11,
wherein the aperture is formed in the second insulating film, and at the same time the metal film essentially containing any one of Mo and Ti is removed to expose the Al film.

13. A semi-transmissive liquid crystal display device which includes:
a first substrate including a transparent electrode which allows light to pass through and a reflective electrode which reflects light;
a second substrate including a common electrode facing both the transparent electrode and the reflective electrode of the first substrate; and
a liquid crystal layer formed of a liquid crystal sealed between the first substrate and the second substrate,
wherein a plurality of dielectric films is interposed between the reflective electrode and the common electrode, and the dielectric films divide a reflective region defined by the reflective electrode into a plurality of regions each having different reflection-applied voltage characteristic from one another.

14. The semi-transmissive liquid crystal display device according to claim 13,
wherein the plurality of dielectric films differs from one another in one or more of thickness, relative dielectric constant and density.

15. The semi-transmissive liquid crystal display device according to claim 13,
wherein the liquid crystal layer is formed of a liquid crystal having negative dielectric anisotropy.

16. The semi-transmissive liquid crystal display device according to claim 13,
wherein the liquid crystal layer is formed of a chiral nematic liquid crystal.

17. The semi-transmissive liquid crystal display device according to claim 13,
wherein some of the plurality of dielectric films is formed on the first substrate, and the others are formed on the second substrate.

18. The semi-transmissive liquid crystal display device according to claim 17,
wherein the dielectric films formed on the second substrate determine the alignment directions of liquid crystal molecules when a voltage is applied.

19. The semi-transmissive liquid crystal display device according to claim 13,
wherein at least one of the plurality of dielectric films has a retardation.

20. The semi-transmissive liquid crystal display device according to claim 13,
wherein at least one of the plurality of dielectric film serves as a λ/4 plate for visible light.

21. The semi-transmissive liquid crystal display device according to claim 13,
wherein at least one of the plurality of dielectric films serves as a color filter.

22. The semi-transmissive liquid crystal display device according to claim 13, further comprising a TFT which is formed in the first substrate and is connected to the reflective electrode and the transparent electrode,
wherein a source electrode of the TFT is formed integrally with the reflective electrode.

23. The semi-transmissive liquid crystal display device according to claim 13,
wherein the reflective electrode covers the TFT.
